(19) United States
(12) Patent Application Publication
(10) Pub. No.: US 2011/0291855 A1
(43) Pub. Date: Dec. 1, 2011

(54) LOGGING TOOL WITH ANTENNAS HAVING EQUAL TILT ANGLES

(76) Inventors: Dean M. Homan, Sugar Land, TX (US); Jian Yang, Sugar Land, TX (US); Jean Seydoux, Rio de Janeiro RJ (BR)

(21) Appl. No.: 13/122,122

(22) PCT Filed: Aug. 25, 2009
(86) PCT No.: PCT/US2009/054840

§ 371 Date: Aug. 19, 2011

Related U.S. Application Data
(60) Provisional application No. 61/101,699, filed on Oct. 1, 2008.

(51) Int. Cl. G01V 3/00

(52) U.S. Cl. 340/853.2

(57) ABSTRACT

The present disclosure relates to a downhole logging tool that includes two or more tilted antennas having equal tilt angles mounted in or on the tool body. The downhole logging tool may be, for example, a wireline or while-drilling tool, and it may be an induction or propagation tool. Various symmetrized and anti-symmetrized responses may be computed and used to infer formation properties and drilling parameters.

### CROSS-REFERENCE TO OTHER APPLICATIONS

This application claims priority to and the benefit of U.S. Provisional Application Ser. No. 61/101699, filed on Oct. 1, 2008.

### BACKGROUND

1. Technical Field

The present application relates generally to logging tools and particularly to electromagnetic logging tools.

2. Background Art

Logging tools have long been used in wellbores to make, for example, formation evaluation measurements to infer properties of the formations surrounding the borehole and the fluids in the formations. Common logging tools include electromagnetic tools, nuclear tools, and nuclear magnetic resonance (NMR) tools, though various other tool-types are also used. Electromagnetic logging tools typically measure the resistivity (or its reciprocal, conductivity) of a formation. Prior art electromagnetic resistivity tools include galvanic tools, induction tools, and propagation tools. Typically a measurement of the attenuation and phase shift of an electromagnetic signal that has passed through the formation is used to determine the resistivity. The resistivity may be that of the virgin formation, the resistivity of what is known as the invasion zone, or it may be the resistivity of the wellbore fluid. In anisotropic formations, the resistivity may be further resolved into components commonly referred to as the vertical resistivity and the horizontal resistivity.

Early logging tools, including electromagnetic logging tools, were run into a wellbore on a wireline cable, after the wellbore had been drilled. Modern versions of such wireline tools are still used extensively. However, the need for information while drilling the borehole gave rise to measurement-while-drilling (MWD) tools and logging-while-drilling (LWD) tools. MWD tools typically provide drilling parameter information such as weight on the bit, torque, temperature, pressure, direction, and inclination. LWD tools typically provide formation evaluation measurements such as resistivity, porosity, and NMR distributions (e.g., T1 and T2). MWD and LWD tools often have characteristics common to wireline tools (e.g., transmitting and receiving antennas), but MWD and LWD tools must be constructed to not only endure but to operate in the harsh environment of drilling.

### SUMMARY

The present disclosure relates to a downhole logging tool that includes two or more tilted antennas having equal tilt angles mounted in or on the tool body. The downhole logging tool may be, for example, a wireline or while-drilling tool, and it may be an induction or propagation tool. Various symmetrized and anti-symmetrized responses may be computed and used to infer formation properties and drilling parameters.

Other aspects and advantages will become apparent from the following description and the attached claims.

### BRIEF DESCRIPTION OF THE FIGURES

FIG. 1 illustrates an exemplary well site system.

FIG. 2 shows a prior art electromagnetic logging tool.

FIG. 3 is a schematic illustration of an embodiment constructed in accordance with the present disclosure.

FIG. 4 is a schematic illustration of an embodiment constructed in accordance with the present disclosure.

FIG. 5 is a schematic illustration of an embodiment constructed in accordance with the present disclosure.

FIG. 6 is a schematic illustration of an embodiment constructed in accordance with the present disclosure.

FIG. 7 is a schematic illustration of an embodiment constructed in accordance with the present disclosure.

FIG. 8 is a schematic illustration of an embodiment constructed in accordance with the present disclosure.

FIG. 9 is a schematic illustration of an embodiment constructed in accordance with the present disclosure.

FIG. 10 is a schematic illustration of an embodiment constructed in accordance with the present disclosure.

FIG. 11 is a schematic illustration of an embodiment constructed in accordance with the present disclosure.

It is to be understood that the drawings are to be used to understand various embodiments and/or features. The figures are not intended to unduly limit any present or future claims related to this application.

### DETAILED DESCRIPTION

Some embodiments will now be described with reference to the figures. Like elements in the various figures will be referenced with like numbers for consistency. In the following description, numerous details are set forth to provide an understanding of various embodiments and/or features. However, it will be understood by those skilled in the art that some embodiments may be practiced without many of these details and that numerous variations or modifications from the described embodiments are possible. As used here, the terms “above” and “below”, “up” and “down”, “upper” and “lower”, “upwardly” and “downwardly”, and other like terms indicating relative positions above or below a given point or element are used in this description to more clearly describe certain embodiments. However, when applied to equipment and methods for use in wells that are deviated or horizontal, such terms may refer to a left to right, right to left, or diagonal relationship as appropriate.

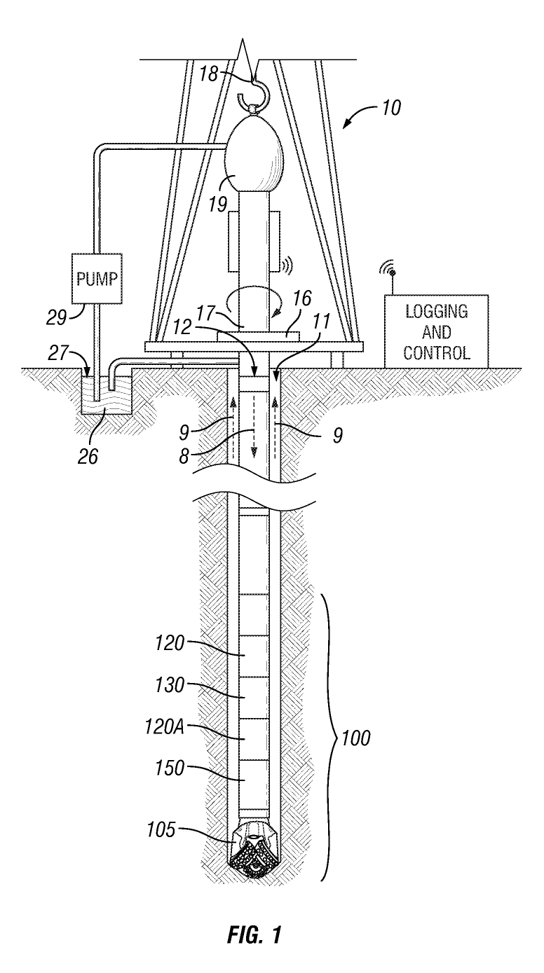

FIG. 1 illustrates a well site system in which various embodiments can be employed. The well site can be onshore or offshore. In this exemplary system, a borehole 11 is formed in subsurface formations by rotary drilling in a manner that is well known. Some embodiments can also use directional drilling, as will be described hereinafter.

A drill string 12 is suspended within the borehole 11 and has a bottom hole assembly 100 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string relative to the hook. As is well known, a top drive system could alternatively be used.

In the example of this embodiment, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this well known manner, the drilling fluid lubricates the drill bit 105 and carries formation cuttings up to the surface as it is returned to the pit 27 for recirculation.

The bottom hole assembly 100 of the illustrated embodiment includes a logging-while-drilling (LWD) module 120, a measuring-while-drilling (MWD) module 130, a roto-steerable system and motor, and drill bit 105.

The LWD module 120 is housed in a special type of drill collar, as is known in the art, and can contain one or a plurality of known types of logging tools. It will also be understood that more than one LWD and/or MWD module can be employed, e.g. as represented at 120A. (References, throughout, to a module at the position of 120 can alternatively mean a module at the position of 120A as well.) The LWD module includes capabilities for measuring, processing, and storing information, as well as for communicating with the surface equipment. In the present embodiment, the LWD module includes a resistivity measuring device.

The MWD module 130 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick/slip measuring device, a direction measuring device, and an inclination measuring device.

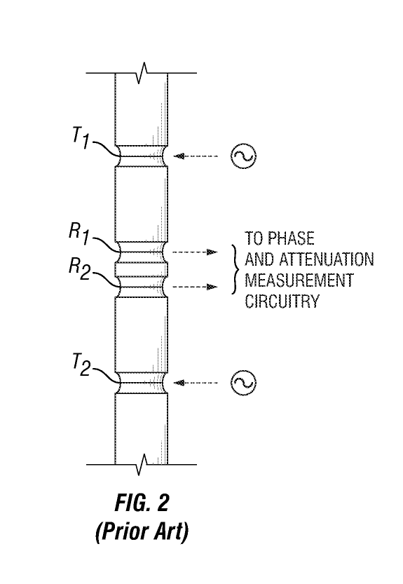

An example of a tool which can be the LWD tool 120, or can be a part of an LWD tool suite 120A of the system and method hereof, is the dual resistivity LWD tool disclosed in U.S. Patent 4,899,112 and entitled “Well Logging Apparatus And Method For Determining Formation Resistivity At A Shallow And A Deep Depth,” incorporated herein by reference. As seen in FIG. 2, upper and lower transmitting antennas, T₁ and T_{2,} have upper and lower receiving antennas, R₁ and R₂, therebetween. The antennas are formed in recesses in a modified drill collar and mounted in insulating material. The phase shift of electromagnetic energy as between the receivers provides an indication of formation resistivity at a relatively shallow depth of investigation, and the attenuation of electromagnetic energy as between the receivers provides an indication of formation resistivity at a relatively deep depth of investigation. The above-referenced U.S. Pat. No. 4,899,112 can be referred to for further details. In operation, attenuation-representative signals and phase-representative signals are coupled to a processor, an output of which is coupleable to a telemetry circuit.

Recent electromagnetic logging tools use one or more tilted or transverse antennas, with or without axial antennas. Those antennas may be transmitters or receivers. A tilted antenna is one whose dipole moment is neither parallel nor perpendicular to the longitudinal axis of the tool. A transverse antenna is one whose dipole moment is perpendicular to the longitudinal axis of the tool, and an axial antenna is one whose dipole moment is parallel to the longitudinal axis of the tool. Two antennas are said to have equal angles if their dipole moment vectors intersect the tool's longitudinal axis at the same angle. For example, two tilted antennas have the same tilt angle if their dipole moment vectors, having their tails conceptually fixed to a point on the tool's longitudinal axis, lie on the surface of a right circular cone centered on the tool's longitudinal axis and having its vertex at that reference point. Transverse antennas obviously have equal angles of 90 degrees, and that is true regardless of their azimuthal orientations relative to the tool.

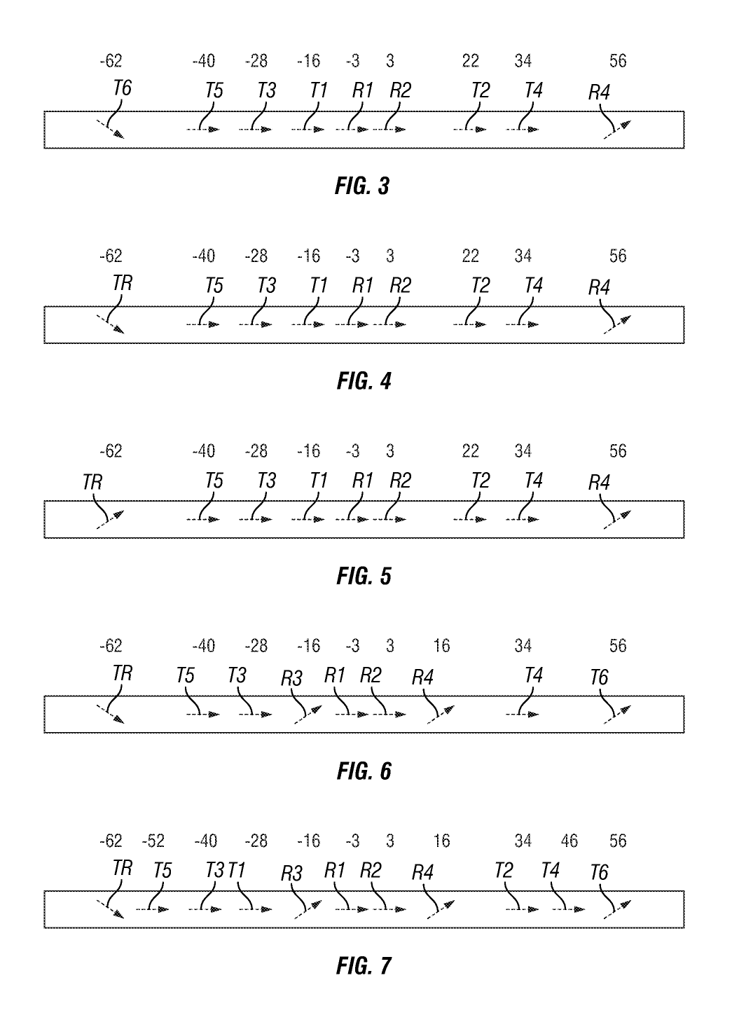

FIG. 3 shows an embodiment having five axially aligned transmitters T1, T2, T3, T4, T5, two axially aligned receivers R1, R2, one tilted receiver R4, and one tilted transmitter T6. The tilted transmitter T6 and tilted receiver R4 have equal tilt angles. The dipole moments of the tilted antennas are shown in the same plane, but are not so limited. The antenna spacings shown are but one example of possible spacings, though different measurements can be made or parameters computed depending on the relative placement of the antennas, as described below. The tool can be used, for example, to obtain horizontal and vertical resistivities and relative dip.

For example, the anisotropy measurements can be defined as:

ATT=20*log ₁₀(abs(V0_T5R2/V0_T5R4))−20*log ₁₀(abs(V0_T6R2/V0_T6R4));

where V0_T5R2 is the 0th harmonic coefficient of the voltage at receiver R2 from transmitter T5, and V0_T5R4 is the 0th harmonic coefficient of the voltage at receiver R4 from transmitter T5. Phase shift can be defined similarly:

PS=−angle(V0_T5R2/V0_T5R4))+angle(V0_T6R2/V0_T6R4).

Both the ATT and PS defined above are sensitive to the resistivity anisotropy, even when used in a vertical well.

The embodiment shown in FIG. 3 can also be used for well placement. For example, the 68″ spacing symmetrized measurements can be defined as:

ATT=20*log ₁₀(abs(Vup_R2T6/Vdn_R2T6))+20*log ₁₀(abs(Vup_R4T1/Vdn_R4T1));

PS=−angle(Vup_R2T6/Vdn_R2T6))−angle(Vup_R4T1/Vdn_R4T1);

where

Vup_R2T6=Vzz_R2T6+Vzx_R2T6;

Vdn_R2T6=Vzz_R2T6-Vzx_R2T6;

Vup_R4T1=Vzz_R4T1+Vxz_R4T1; and

Vdn_R4T1=Vzz_R4T1−Vxz_R4T1.

Vzz_R2T6 and Vzx_R2T6 are the zz and zx coupling components of the signal from transmitter T6 received by receiver R2.

Similarly, the 118″ spacing symmetrized measurements can be defined as:

ATT=20*log ₁₀(abs(Vup_R4T6/Vdn_R4T6));

PS=−angle(Vup_R4T6/Vdn_R4T6));

where

Vup_R4T6=0.5(Vxx_R4T6+Vyy_R4T6)-Vzz_R2T6+(Vxz_R4T6-Vzx_R4T6); and

Vdn_R4T6=0.5(Vxx_R4T6+Vyy_R4T6)-Vzz_R2T6-(Vxz_R4T6-Vzx_R4T6).

Vxx_R4T6, Vyy_R4T6, Vzz_R4T6, Vxz_R4T6, and Vzx_R4T6 are, respectively, the xx, yy, zz, xz, and zx coupling components of the signal from transmitter T6 received by receiver R4. One can obtain 0.5(Vxx_R4T6+Vyy_R4T6)-Vzz_R2T6 and Vxz_R4T6-Vzx_R4T6 by curve fitting.

FIG. 4 shows an embodiment having five axially aligned transmitters T1, T2, T3, T4, T5, two axially aligned receivers R1, R2, one tilted receiver R4, and one tilted transceiver TR. The tilted transceiver TR and tilted receiver R4 have equal tilt angles. The dipole moments of the tilted antennas are shown in the same plane, but are not so limited. The tool can be used to obtain horizontal and vertical resistivities, relative dip, and perform well placement in the same or similar manner as that discussed in relation to FIG. 3. This configuration also allows symmetrized directional measurements at 34″ and 96″.

The embodiment of FIG. 5 is similar to that of FIG. 4 except the transceiver TR and receiver R4 dipole moments are parallel. This is a special case of the embodiment of FIG. 4. The tool can be used to obtain horizontal and vertical resistivities, relative dip, and perform well placement in the same or similar manner as that discussed in relation to FIG. 3. This configuration also allows a symmetrized directional measurement at 68″.

FIG. 6 shows an embodiment having three axially aligned transmitters T3, T4, T5, two axially aligned receivers R1, R2, two tilted receivers R3, R4, one tilted transmitter T6 and one tilted transceiver TR. The tilted antennas have equal tilt angles. The dipole moments of the tilted antennas are shown in the same plane, but are not so limited. The spacing among the antennas varies slightly from embodiments previously discussed, so measurement spacings differ. The tool can be used, for example, to obtain horizontal and vertical resistivities, relative dip, and well placement.

The 68″ symmetrized directional measurements can be defined the same way as for the embodiment of FIG. 5. This embodiment does not allow for 118″ symmetrized measurements, but one can instead define anti-symmetrized measurements:

ATT=20*log ₁₀(abs(Vup_R4T6/Vdn_R4T6));

PS=−angle(Vup_R4T6/Vdn_R4T6));

where

Vup_R4T6=0.5(Vxx_R4T6+Vyy_R4T6)-Vzz_R2T6+(Vxz_R4T6+Vzx_R4T6);

Vdn_R4T6=0.5(Vxx_R4T6+Vyy_R4T6)-Vzz_R2T6−(Vxz_R4T6+Vzx_R4T6); and

Vxx_R4T6, Vyy_R4T6, Vzz_R4T6, Vxz_R4T6, and Vzx_R4T6 are, respectively, the xx, yy, zz, xz, and zx coupling components of the signal from transmitter T6 received by receiver R4. One can obtain 0.5(Vxx_R4T6+Vyy_R4T6)-Vzz_R2T6 and Vxz_R4T6+Vzx_R4T6 by curve fitting.

FIG. 7 shows an embodiment having five axially aligned transmitters T1, T2, T3, T4, T5, two axially aligned receivers R1, R2, two tilted receivers R3, R4, one tilted transmitter T6, and one tilted transceiver TR. This is similar to the embodiment of FIG. 6, but with two additional axial transmitters T1, T2. The tilted antennas have equal tilt angles. The dipole moments of the tilted antennas are shown in the same plane, but are not so limited. The additional antennas allow for additional measurement spacings. The tool can be used, for example, to obtain horizontal and vertical resistivities, relative dip, and well placement.

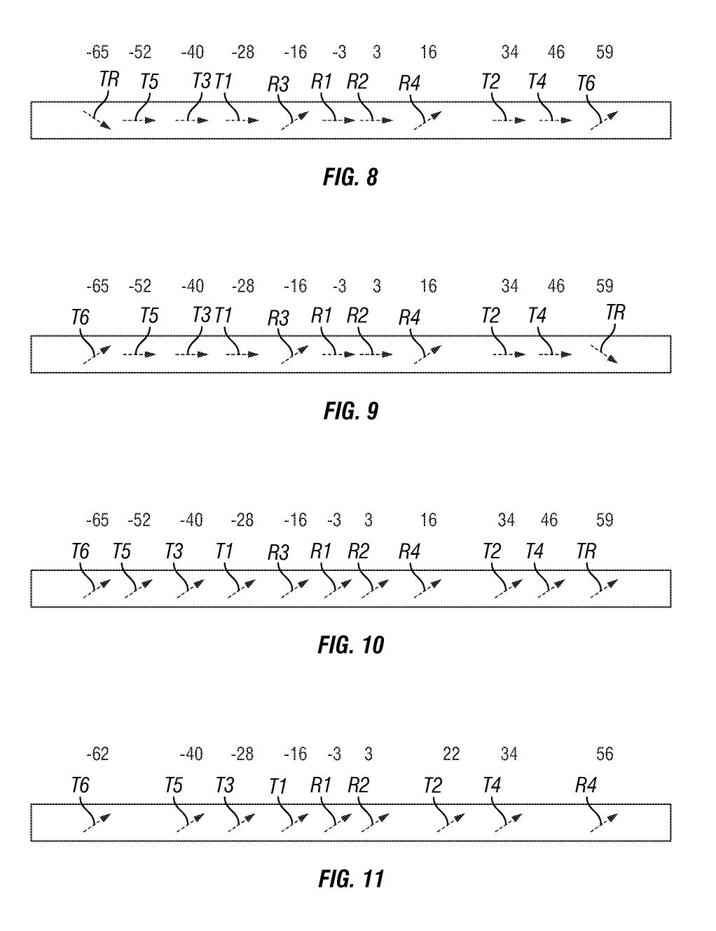

FIG. 8 shows an embodiment similar to that of FIG. 7, but has different spacings for the transceiver TR and tilted transmitter T6. The different spacings allow for deeper measurements. Anisotropy measurements can be defined as:

ATT=20*log ₁₀(abs(V0_TR3/V0_TR4))+20*log₁₀(abs(V0_T6R4/V0_T6R3));

where V0_TR3 and V0_TR4 are the 0th harmonic coefficients of the voltages at receivers R3 and R4 from transceiver TR respectively; and V0_T6R3 and V0_T6R4 are the 0th harmonic coefficients of the voltages at receiver R3 and R4 from transmitter T6, respectively. Phase shift can be defined in the same way:

PS=angle(V0_TR3/V0_TR4))+angle(V0_T6R4/V0_T6R3);

Both the ATT and PS, as so defined, are sensitive to the resistivity anisotropy, even for a vertical well.

Referring back to FIG. 7, the symmetrized measurements at 46″, 78″, and 118″ are defined in the same way as for the embodiment shown in FIG. 5 except for different transmitter-receiver pairs. The 46″ symmetrized measurement comes from the TR-R3 pair, the 78″ measurement comes from TR-R4 pair, and the 118″ measurement comes from T6-TR pair.

The anti-symmetrized measurements at 40″ and 72″ are defined similar to the above except for different transmitter-receiver pairs: the 40″ measurement is obtained from the T6-R4 pair, and the 72″ measurement is obtained from the T6-R3 pair. FIG. 9 shows an embodiment similar to that of FIG. 8, but T6 and TR are interchanged.

FIGS. 10 and 11 shows embodiments in which all antennas are tilted at equal angles. While they are shown with the dipole moments being co-planar and parallel, they are not so limited. FIGS. 10 and 11 show different numbers of antennas and different spacings. The tools can be used, for example, to obtain horizontal and vertical resistivities, relative dip, and well placement.

While preferred embodiments have been described herein, those skilled in the art, having benefit of this disclosure, will appreciate that other embodiments are envisioned that do not depart from the inventive scope of the present application. Accordingly, the scope of the present claims or any subsequent related claims shall not be unduly limited by the description of the preferred embodiments herein.

What is claimed is:

1. A downhole logging tool, comprising:
a tool body having a longitudinal axis; and
two or more tilted antennas having equal tilt angles mounted in or on the tool body.

2. The logging tool of claim 1, wherein the logging tool is a wireline tool or a while-drilling tool.

3. The logging tool of claim 1, wherein the logging tool is an induction tool or a propagation tool.

4. The logging tool of claim 1, wherein the tool body is made of non-magnetic metal.

5. The logging tool of claim 1, wherein the antennas are disposed in a recess of the tool body.

6. The logging tool of claim 1, wherein at least one of the tilted antennas is a transmitter or transceiver and at least one of the other tilted antennas is a receiver or transceiver.

7. The logging tool of claim 1, wherein at least one of the tilted antennas is a transceiver, and further comprising two or more axial antennas mounted in or on the tool body.

8. The logging tool of claim 7, wherein at least two of the axial antennas are receivers.

9. The logging tool of claim 8, wherein at least two of the axial receiver antennas are adjacent one another, and further comprising a first tilted receiver antenna located adjacent one end of the adjacent axial receiver antennas and a second tilted receiver antenna located adjacent the opposite end of the two adjacent axial receiver antennas.

10. The logging tool of claim 1, wherein the antennas are spaced along the longitudinal axis to provide symmetrized and/or anti-symmetrized measurements.

11. The logging tool of claim 1, wherein at least two of the tilted antennas have dipole moments that lie in the same plane.

12. The logging tool of claim 1, wherein at least two of the tilted antennas have dipole moments that are parallel.

13. A downhole logging tool, comprising:
a tool body having a longitudinal axis;
two or more tilted antennas having equal tilt angles mounted in or on the tool body and spaced along the longitudinal axis, wherein at least one of the tilted antennas is a transceiver; and
two or more axial antennas mounted in or on the tool body and spaced along the longitudinal axis to provide symmetrized and/or anti-symmetrized measurements when used in conjunction with the tilted antennas.

14. A method to log a wellbore, comprising:
providing a downhole logging tool comprising a tool body having a longitudinal axis, and two or more tilted antennas having equal tilt angles mounted in or on the tool body; and
making measurements while the logging tool is in the wellbore.

15. The method of claim 14, wherein the making measurements is performed while drilling the wellbore.

16. The method of claim 14, wherein the making measurements is performed while drilling the wellbore, but while the logging tool is not rotating.

17. The method of claim 14, further comprising determining formation properties and/or other downhole parameters from the measurements.

18. The method of claim 17, wherein the formation properties and other downhole parameters include resistive anisotropy, relative dip, azimuth, and distances to bed boundaries.

19. The method of claim 17, further comprising making drilling decisions based on the determined formation properties and/or other downhole parameters.

20. The method of claim 14, further comprising using multiple frequencies to make measurements at multiple depths of investigation.
